(19) United States
(12) Patent Application Publication
(10) Pub. No.: US 2016/0057235 A1
(43) Pub. Date: Feb. 25, 2016

(54) SERVER CLUSTER SYSTEM

(71) Applicant: WISTRON CORPORATION, New Taipei City (TW)

(72) Inventors: Po-Min Wu, New Taipei City (TW); Kuan-Lin Liu, New Taipei City (TW); Jhih-Yuan Sie, New Taipei City (TW)

(21) Appl. No.: 14/689,814

(22) Filed: Apr. 17, 2015

(30) Foreign Application Priority Data
Aug. 21, 2014 (TW) 103128828

(51) Int. Cl. H04L 29/08

(52) U.S. Cl. CPC H04L 67/16

(57) ABSTRACT

A server unit of a server cluster system includes a plurality of servers. Each server generates status information that is associated therewith. A positioning unit of the server cluster system is configured to communicate with the server unit and stores a plurality of position indices. The position indices are respectively associated with positions of the servers of the server unit. A host device of the server cluster system is coupled to one of the server unit and the positioning unit for receiving the status information and the position indices therefrom.

### CROSS-REFERENCE TO RELATED APPLICATION

This application claims priority of Taiwanese Application No. 103128828, filed on Aug. 21, 2014.

### FIELD

The present disclosure relates to a server cluster system, more particularly to a server cluster system with a plurality of servers that can be easily located.

### BACKGROUND

A general server system includes a host device and a plurality of servers that are disposed in a machine room. The host device is configured to receive status information of each of the servers so as to monitor the servers. When maintenance personnel want to maintain a particular one of the servers in the machine room, a conventional way of finding the particular server is to flash an indicator of the particular server under control of the host device such that the maintenance personnel can look for the flashing indicator to find the particular server after examining thoroughly the machine room. However, in such way the maintenance personnel may spend a lot of time searching back and forth in the machine room for the particular server.

### SUMMARY

Therefore, an object of the present disclosure is to provide a server cluster system that may alleviate the above drawback of the prior art.

Accordingly, a server cluster system of the present disclosure includes a server unit, a positioning unit and a host device.

The server unit includes a plurality of servers. Each of the servers generates status information that is associated therewith. The positioning unit is configured to communicate with the server unit and stores a plurality of position indices. The position indices are respectively associated with positions of the servers of the server unit. The host device is coupled to one of the server unit and the positioning unit for receiving the status information and the position indices from the one of the server unit and the positioning unit.

Another aspect of the server cluster system of the present disclosure includes a server unit, a plurality of network communication modules and a host device.

The server unit includes a plurality of servers. Each of the servers generates status information that is associated therewith. The network communication modules are connected electrically and respectively to the servers. Each of the network communication modules stores a unique network address. The host device is coupled to the network communication modules and stores a plurality of reference addresses and a plurality of position indices. The position indices correspond respectively to the reference addresses and are associated respectively with positions of the servers. Each of the network communication modules is configured to receive the status information from the respective one of the servers, and to send the status information received from the respective one of the servers and the network address stored therein to the host device.

### BRIEF DESCRIPTION OF THE DRAWINGS

Other features and advantages of the present disclosure will become apparent in the following detailed description of the embodiments with reference to the accompanying drawings, of which:

FIG. 1 is a schematic block diagram of a first embodiment of a server cluster system according to the present disclosure for illustrating connection relationship among electrical components thereof;

FIG. 2 is a schematic view of the first embodiment including a plurality of server units;

FIG. 3 is a schematic block diagram of a second embodiment of the server cluster system according to the present disclosure for illustrating connection relationship among electrical components thereof;

FIG. 4 is a schematic block diagram of a third embodiment of the server cluster system according to the present disclosure for illustrating connection relationship among electrical components thereof; and

FIG. 5 is a schematic block diagram of a fourth embodiment of the server cluster system according to the present disclosure for illustrating connection relationship among electrical components thereof.

### DETAILED DESCRIPTION

Before the present disclosure is de scribed in greater detail, it should be noted that like elements are denoted by the same reference numerals throughout the disclosure.

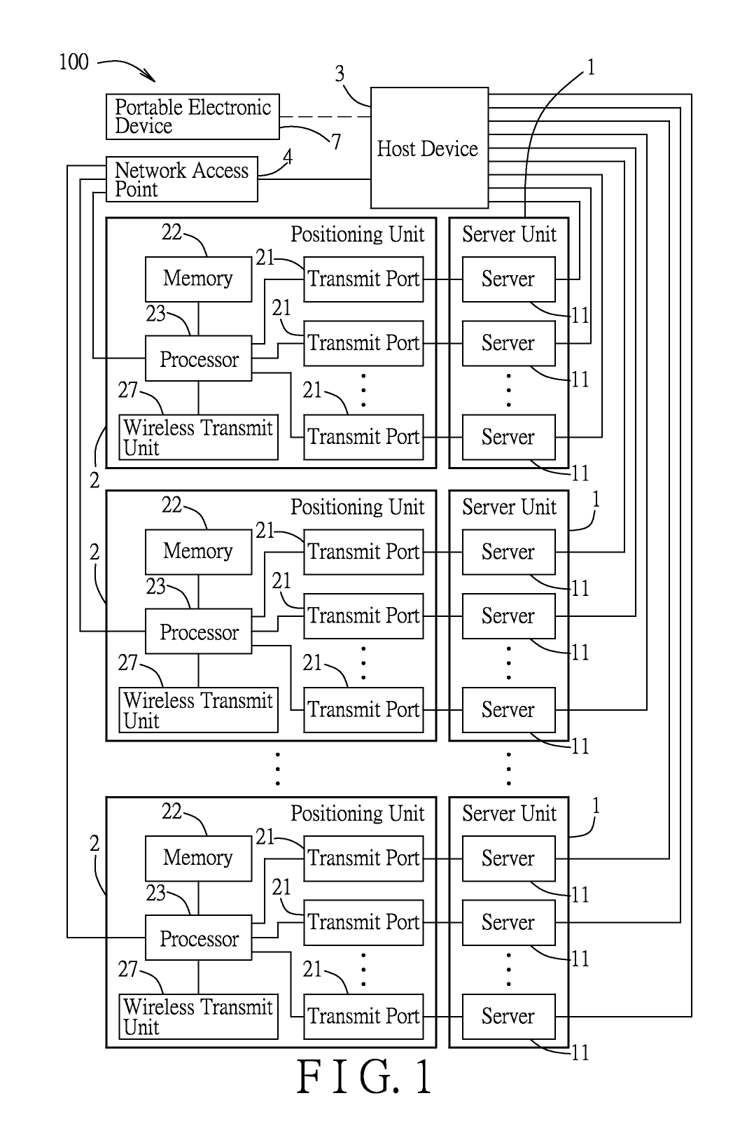

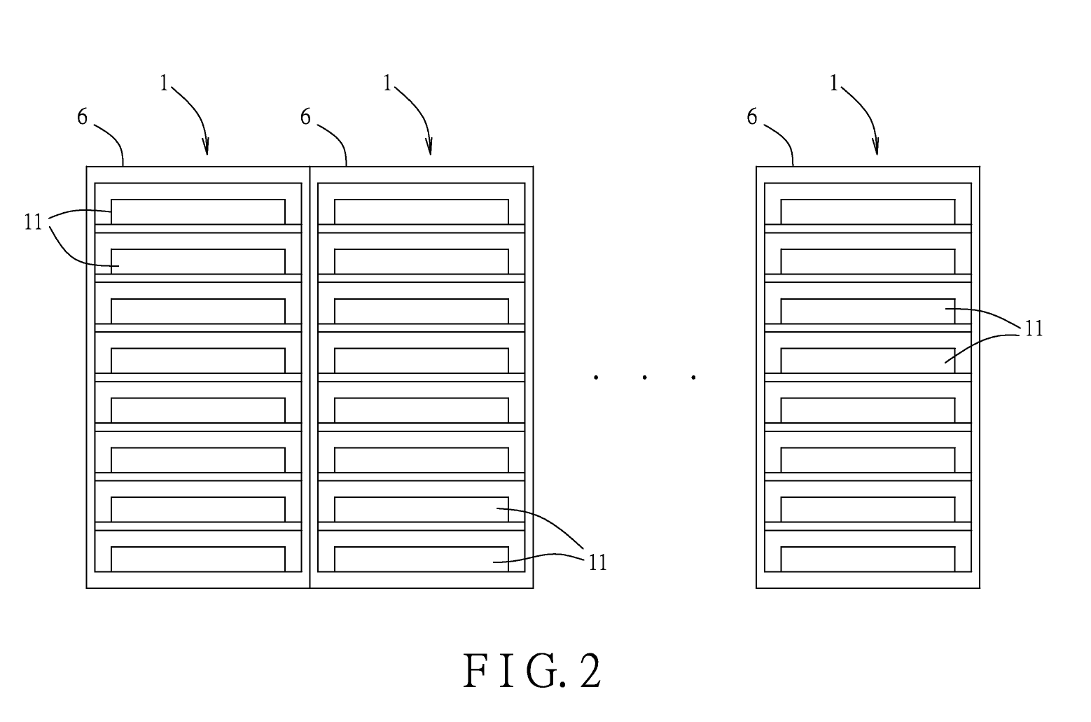

Referring to FIGS. 1 and 2, a first embodiment of a server cluster system 100 according to the present disclosure includes a plurality of server units 1, a plurality of positioning units 2, a host device 3, a network access point 4 and a portable electronic device 7.

The server units 1 are disposed on a plurality of cabinets 6, respectively. Each of the server units 1 includes a plurality of servers 11 that are connected electrically to the host device 3. The servers 11 of each server unit 1 align along a vertical direction of the respective cabinet 6. Herein, the cabinets 6 are arranged in a matrix array. Each of the servers 11 is configured to generate status information that is associated therewith. The status information may include temperature of the server 11 and so forth, but should not be limited thereto.

The positioning units 2 are configured to respectively communicate with the server units 1, and are more specifically connected electrically to the server units 1, respectively in this embodiment. In this embodiment, each of the positioning units 2 includes a plurality of transmit ports 21, a memory 22, a wireless transmit unit 27, and a processor 23 that is connected electrically to the transmit ports 21, the memory 22 and the wireless transmit unit 27. The transmit ports 21 of each of the positioning units 2 are connected electrically and respectively to the servers 11 of one of the server units 1 that is connected electrically to said positioning unit 2. The memory 22 of each of the positioning units 2 stores a plurality of position indices and a server identifier. The position indices stored in the memory 22 of each of the positioning units 2 are respectively associated with positions of the servers 11 of the server unit 1 to which said positioning unit 2 is electrically connected, and correspond respectively to the transmit ports 21 of said positioning unit 2. The server identifier stored in the memory 22 of each of the positioning units 2 is associated with the server unit 1 to which said positioning unit 2 is electrically connected. The processor 23 is operable to control transmission of a wireless positioning signal by the wireless transmit unit 27.

The host device 3 stores first position data associated respectively with positions of the server units 1, and a plurality of reference identifiers corresponding respectively to the first position data. The network access point 4 is connected electrically between the processors 23 of the positioning units 2 and the host device 3.

Each of the servers 11 of each of the server units 1 is configured to send the status information generated thereby to the transmit port 21 that is connected electrically thereto. The processor 23 of each of the positioning units 2 is configured to send, the status information received from each of the transmit ports 21, along with the server identifier stored in the memory 22 and the position index stored in the memory 22 and corresponding to the transmit port 21, to the host device 3 via the network access point 4. The host device 3 is configured to correlate the status information and the position index with one of the first position data stored therein according to the server identifier. Specifically, the host device 3 is configured to locate the first position data with reference to the reference identifier that conforms with the server identifier received from the processor 23. In this embodiment, each of the position indices has second position data that is associated with the position of the respective one of the servers 11. The first position data includes a pair of first and second coordinates (X and Y) in a three-dimensional coordinate system, and for each of the position indices, the second position data represents a third coordinate (Z) in the three-dimensional coordinate system. Therefore, the host device 3 is able to obtain status information and position index of each of the servers 11 of each of the server units 1 so as to provide information on the current status and complete three-dimensional coordinates of each of the servers 11 to maintenance personnel.

The portable electronic device 7 stores a map, and is configured to receive the first and second position data (i.e., the three-dimensional coordinates) of the servers 11 from the host device 3. The portable electronic device 7 is configured to display the map and to mark the position of at least one of the servers on the map according to the three-dimensional coordinates that correspond to said at least one of the servers 11. Moreover, the portable electronic device 7 is configured to receive the wireless positioning signals transmitted by the wireless transmit units 27 of the positioning units 2, to calculate a current position of the portable electronic device 7 according to the wireless positioning signals, and to mark the current position of the portable electronic device 7 on the map. The portable electronic device 7 may be a tablet, but should not be limited thereto. Therefore, when the maintenance personnel want to maintain a particular one of the servers 11, it will be easy and efficient for the maintenance personnel to find and approach the particular server 11 under guidance of the marked-up map displayed on the portable electronic device 7.

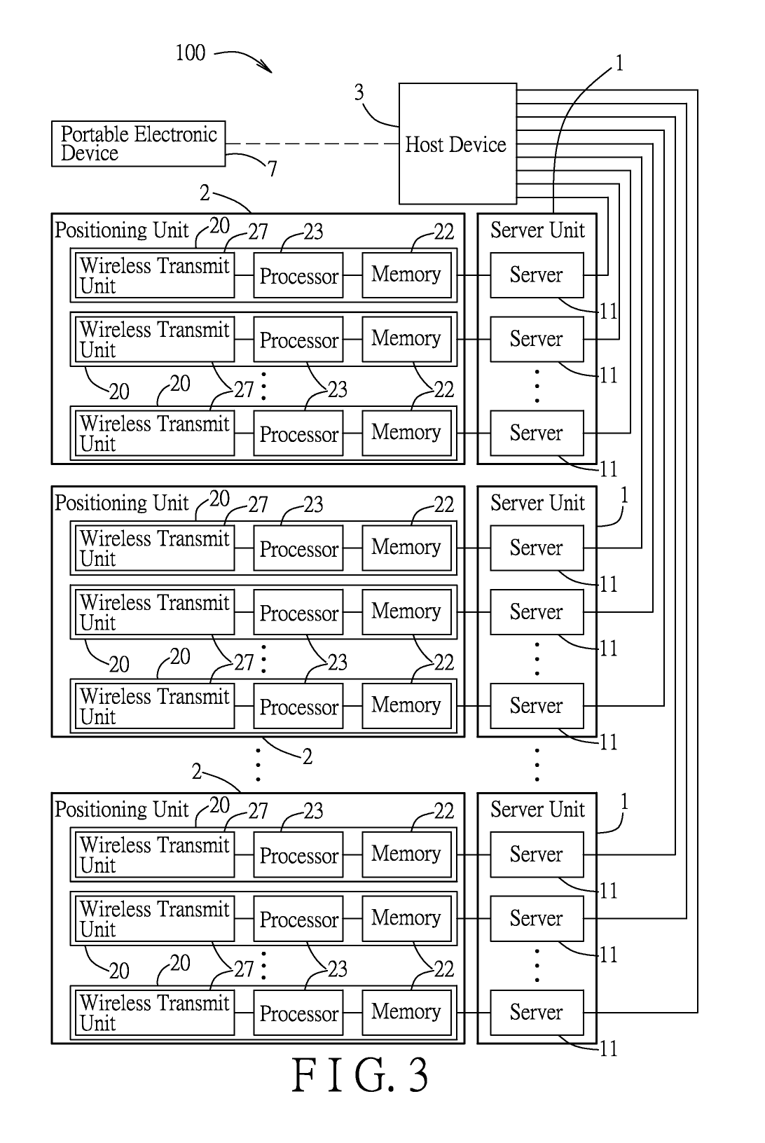

Referring to FIG. 3, a second embodiment of the server cluster system 100 according to the present disclosure includes a plurality of server units 1, a plurality of positioning units 2, a host device 3 and a portable electronic device 7. The server units 1 and the portable electronic device 7 of this embodiment are similar to those in the first embodiment, and thus detailed descriptions thereof are omitted herein for the sake of brevity.

The positioning units 2 are connected electrically to the server units 1, respectively. Each positioning unit 2 includes a plurality of positioning modules 20. The positioning modules 20 of each of the positioning units 2 are connected electrically and respectively to the servers 11 of one of the server units 1 that is connected electrically to said positioning unit 2. Each of the positioning modules 20 includes a memory 22, a wireless transmit unit 27 and a processor 23 connected electrically to the wireless transmit unit 27. The processor 23 is configured to control the wireless transmit unit 27 to output a wireless positioning signal that is for the portable electronic device 7 to calculate a current position thereof. In this embodiment, each of the positioning modules 20 and the respective one of the servers 11 are connected by a USB interface. The memory 22 of each of the positioning modules 20 stores a position index associated with the position of the respective one of the servers 11 to which said positioning module 20 is connected. The position index stored in the memory 22 of each of the positioning modules 20 includes a set of three coordinates (X, Y, Z) that are in a three-dimensional coordinate system of the map and that are associated with the position of the respective one of the servers 11 to which said positioning module 20 is connected.

Each of the servers 11 is configured to acquire the position index from the memory 22 of the respective positioning module 2 that is connected electrically thereto, and to send the received position index and the generated status information to the host device 3. Therefore, the host device 3 may obtain status information and position index of each of the servers 11 of each of the server units 1 so as to provide information on the current status and complete three-dimensional coordinates of each of the servers 11 to the maintenance personnel. Moreover, the host device 3 may send the position index (i.e., three-dimensional coordinates of the particular server 11) to the portable electronic device 7 to be marked on the map displayed thereon such that it will be easy and efficient for the maintenance personnel to find and approach the particular server 11 under guidance of the portable electronic device 7.

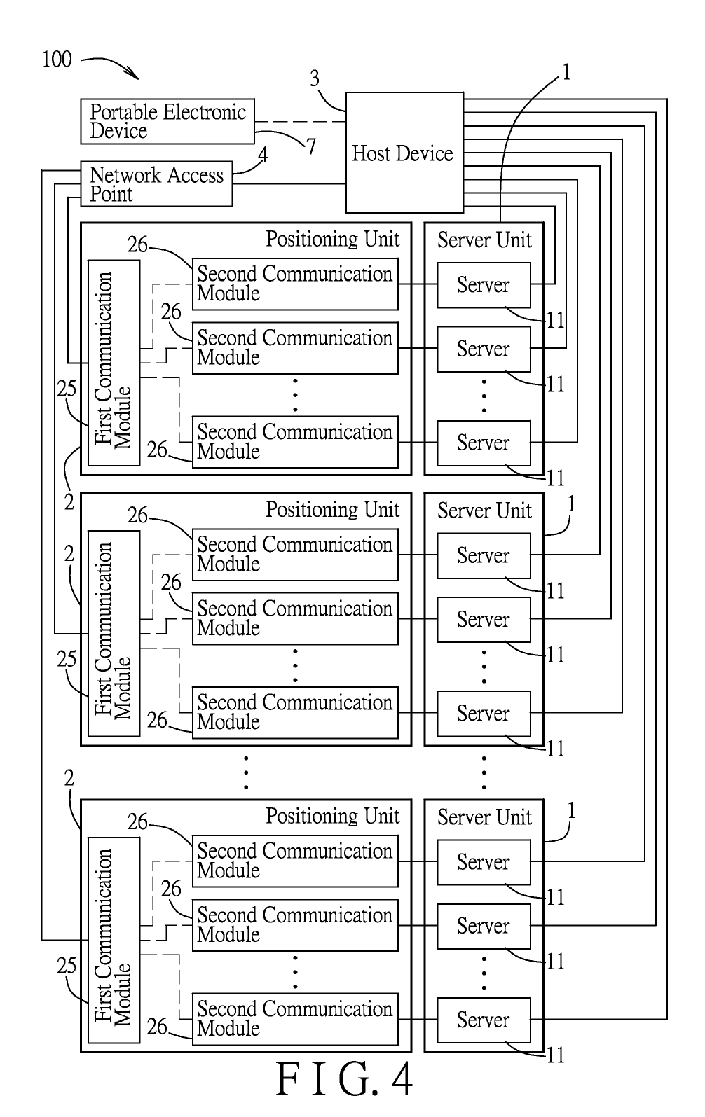

Referring to FIG. 4, a third embodiment of the server cluster system 100 according to the present disclosure includes a plurality of server units 1, a plurality of positioning units 2, a host device 3, a network access point 4 and a portable electronic device 7. The server units 1 and the portable electronic device 7 of this embodiment are similar to those in the first embodiment, and thus detailed descriptions thereof are omitted herein for the sake of brevity.

The positioning units 2 are connected electrically to the server units 1, respectively. Each of the positioning units 2 includes a first communication module 25 and a plurality of second communication modules 26. The second communication modules 26 of each of the positioning units 2 are connected electrically and respectively to the servers 11 of one of the server units 1 that is connected electrically to said positioning unit 2. In this embodiment, each of the second communication modules 26 and the respective one of the servers 11 are connected by a USB interface. The first communication module 25 of each of the positioning units 2 stores first position data. The first position data is associated with a position of the server unit 1 that is connected electrically to said positioning unit 2. Each of the second communication modules 26 of each of the positioning units 2 stores a position index. The position index is associated with a position of the server 11 that is connected electrically to said second communication module 26. The position index includes a second position data that is associated with the position of the server 11 to which said second communication module 26 is connected. In this embodiment, the first position data includes a pair of first and second coordinates (X and Y) in a three-dimensional coordinate system of the map, and the second position data represents a third coordinate (Z) in the three-dimensional coordinate system. The network access point 4 is connected electrically between the host device 3 and the first communication modules 25 of the positioning units 2.

Each of the servers 11 of each of the server units 1 is configured to send the generated status information to the respective second communication module 26 that is connected electrically to said server 11. Each of the second communication modules 26 is configured to send wirelessly the status information received thereby and the position index stored thereby to the first communication module 25. The first communication module 25 is configured to send to the host device 3 via the network access point 4 the status information and the position index received from each of the second communication modules 26, and the first position data stored in the first communication module 25. Therefore, the host device 3 may obtain the status information and complete three-dimensional coordinates of each of the servers 11 of each of the server units 1. Moreover, the host device 3 may send the three-dimensional coordinates of any particular server 11 to the portable electronic device 7 such that it will be easy and efficient for the maintenance personnel to find and approach the particular server 11 under guidance of the portable electronic device 7. In this embodiment, the second communication module 26 is configured to output a wireless positioning signal that is for the portable electronic device 7 to calculate a current position thereof. In another aspect of the present disclosure, the first communication module 25 may also be configured to output a wireless positioning signal that is for the portable electronic device 7 to calculate a current position thereof.

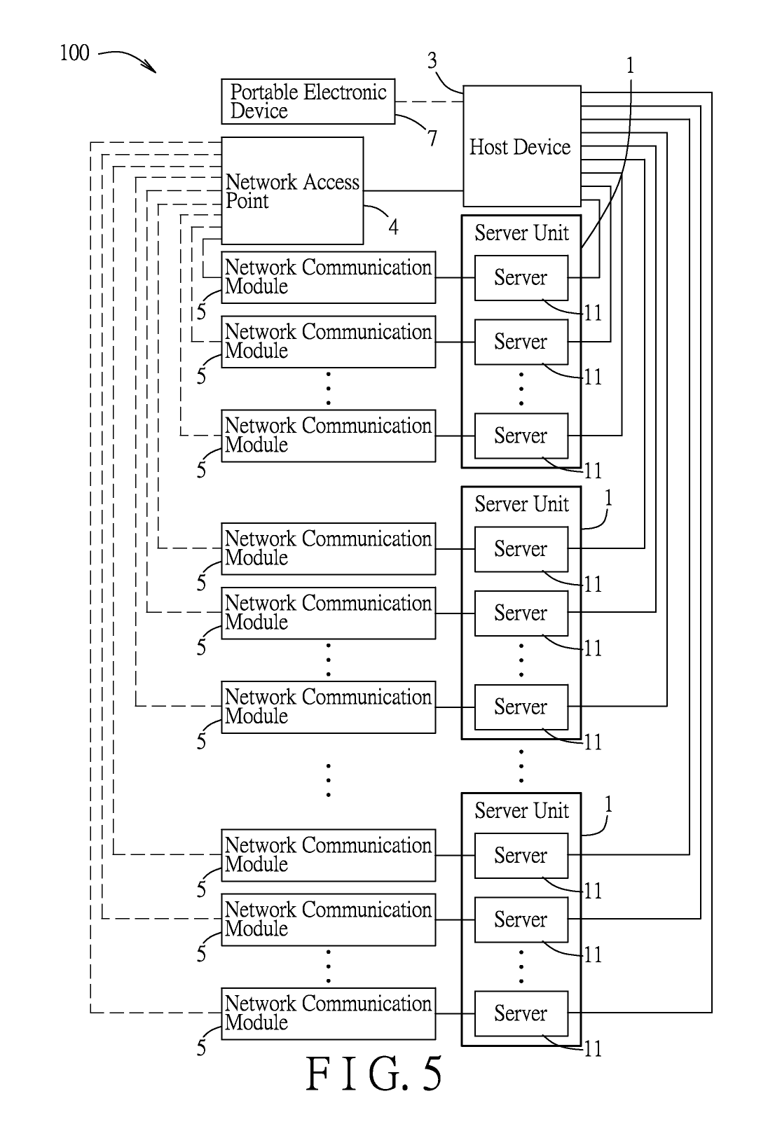

Referring to FIG. 5, a fourth embodiment of the server cluster system 100 of the present disclosure includes a plurality of server units 1, each including a plurality of servers 11, a plurality of network communication modules 5, a host device 3, a network access point 4 connected electrically to the host device 3, and portable electronic device 7. The server units 1 and the portable electronic device 7 of this embodiment are similar to those in the first embodiment, and thus detailed descriptions thereof are omitted herein for the sake of brevity.

The network communication modules 5 are connected electrically to the servers 11 of the server units 1, respectively. Each of the network communication modules 5 is configured to output a wireless positioning signal that is for the portable electronic device 7 to calculate a current position thereof. Each of the network communication modules 5 stores a unique media access control (MAC) address. The host device 3 is in communication with the network communication modules 5 through the network access point 4, and stores a plurality of reference addresses and a plurality of position indices. The position indices correspond respectively to the reference addresses and are associated respectively with positions of the servers 11 of the server units 1. In this embodiment, each of the position indices includes a set of three coordinates (X, Y and Z) that are in a three-dimensional coordinate system of the map and that are associated with the position of the respective server 11.

Each of the network communication modules 5 is configured to receive the status information from the respective server 11 that is connected electrically to said network communication module 5, and to send the status information received thereby and the MAC address stored therein to the host device 3 via the network access point 4. In this embodiment, each of the network communication modules 5 sends wirelessly the status information and the MAC address to the network access point 4. After receiving the status information and the MAC address, the host device 3 may correlate the status information with one of the position indices according to the MAC address. Specifically, based on the MAC address received from one of the network communication modules 5, the host device 3 is able to locate one of the position indices with reference to the reference address that conforms to the MAC address received from said network communication module 5. Therefore, the host device 3 may obtain the status information of each of the servers 11 of each of the server units 1 so as to provide information on the current status and complete three-dimensional coordinates of each of the servers 11 to the maintenance personnel. Furthermore, the host device 3 is configured to send the three-dimensional coordinates of any server 11 to the portable electronic device 7 such that it will be easy and efficient for the maintenance personnel to find and approach the particular server 11 under guidance of the portable electronic device 7.

Referring back to FIG. 2, it is understood that the second position data (i.e., the Z coordinate) in the abovementioned first to fourth embodiments may also represent a level of the cabinet 6 in the vertical direction where a corresponding one of the servers 11 is disposed. For example, the cabinet 6 in FIG. 2 has eight levels. When the Z coordinate associated with a particular server 11 is five, it can be inferred that the particular server 11 is disposed on the fifth level of the cabinet 6 from the bottom, with the position of the cabinet 6 being indicated by the X and Y coordinates.

Moreover, it should be apparent from the above-described embodiments that the host device 3 may be coupled to either the server units 1 or the positioning units 2 for receiving the status information and the position indices therefrom.

To conclude, by coordination of the positioning units 2 and the host device 3 of the present disclosure, the server cluster system 100 may enable the host device 3 to provide the maintenance personnel with both the status information and the position of each of the servers 11. Moreover, the maintenance personnel may easily find and approach any particular server 11 under guidance of the map and markings thereon displayed on the portable electronic device 7.

While the present disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A server cluster system, comprising:
a server unit including a plurality of servers, each of said servers generating status information that is associated therewith;
a positioning unit configured to communicate with said server unit and storing a plurality of position indices, the position indices being respectively associated with positions of said servers of said server unit; and
a host device coupled to one of said server unit and said positioning unit for receiving the status information and the position indices from said one of said server unit and said positioning unit.

2. The server cluster system as claimed in claim 1, wherein said host device stores first position data that is associated with a position of said server unit, and a reference identifier that corresponds to the first position data, and said positioning unit includes:
a plurality of transmit ports each connected electrically to a respective one of said servers for receiving the status information therefrom;
a memory storing the position indices and a server identifier that corresponds to said server unit, each of the position indices having second position data that is associated with the position of the respective one of said servers; and
a processor connected electrically to said transmit ports and said memory, being operable to communicate with said host device to send the status information received from each of said servers, and the server identifier and the position indices stored in said memory to said host device.

3. The server cluster system as claimed in claim 2, wherein said host device is configured to locate the first position data with reference to the reference identifier that conforms with the server identifier received from said processor.

4. The server cluster system as claimed in claim 3, wherein said positioning unit further includes a wireless transmit unit connected electrically to said processor and controlled by said processor to output a wireless positioning signal;
wherein said server cluster system further comprises a portable electronic device that stores a map, and that is configured to
receive, from said host device, the first position data located by said host device, and the second position data received by said host device from said processor,
receive the wireless positioning signal and calculate a current position of said portable electronic device according to the wireless positioning signal, and
display the map, mark the position of one of said servers on the map according to the first position data and the second position data that corresponds to said one of said servers, and mark the current position of said portable electronic device on the map.

5. The server cluster system as claimed in claim 4, wherein the first position data includes a pair of first and second coordinates in a three-dimensional coordinate system of the map, and for each of the position indices, the second position data represents a third coordinate in the three-dimensional coordinate system.

6. The server cluster system as claimed in claim 2, further comprising a network access point connected electrically between said processor of said positioning unit and said host device,
wherein said processor is configured to send the status information, the server identifier and the position indices to said host device via said network access point.

7. The server cluster system as claimed in claim 1, wherein said positioning unit includes a plurality of positioning modules each connected electrically to a respective one of said servers and storing the position index associated with the position of the respective one of said servers;
wherein each of said servers is configured to acquire the position index from the respective one of said positioning modules, and to send the position index and the status information to said host device.

8. The server cluster system as claimed in claim 7, wherein each of said positioning modules includes a memory storing the position index, a wireless transmit unit, and a processor connected electrically to said wireless transmit unit and configured to control said wireless transmit unit to output a wireless positioning signal;
wherein said server cluster system further comprises a portable electronic device that stores a map and that is configured to
receive the position index from said host device,
receive the wireless positioning signal and calculate a current position of said portable electronic device according to the wireless positioning signal, and
display the map, mark the position of one of said servers on the map according to the position index that corresponds to said one of said servers, and mark the current position of said portable electronic device on the map.

9. The server cluster system as claimed in claim 8, wherein the position index stored in said memory of each of said positioning modules includes a set of three coordinates that are in a three-dimensional coordinate system of the map and that are associated with the position of the respective one of said servers to which said positioning module is connected.

10. The server cluster system as claimed in claim 1, wherein said positioning unit includes:
a first communication module configured to communicate with said host device, storing first position data that is associated with a position of said server unit; and
a plurality of second communication modules each connected electrically to a respective one of said servers and storing the position index associated with the position of the respective one of said servers, the position index including a second position data that is associated with a position of the respective one of said servers;
wherein each of said servers is configured to send the status information to the respective one of said second communication modules, each of said second communication modules is configured to send the status information received thereby and the position index stored thereby to said first communication module, and said first communication module is configured to send to said host device the status information and the position index received from each of said second communication modules, and the first position data.

11. The server cluster system as claimed in claim 10, wherein at least one of said first and second communication modules is con figured to output a wireless positioning signal;
wherein said server cluster system further comprises a portable electronic device that stores a map and that is configured to
receive the position index and the first position data from said host device,
receive the wireless positioning signal and calculate a current position of said portable electronic device according to the wireless positioning signal, and
display the map, mark the position of one of said servers on the map according to the position index that corresponds to said one of said servers and the first position data, and mark the current position of said portable electronic device on the map.

12. The server cluster system as claimed in claim 11, wherein the first position data includes a pair of first and second coordinates in a three-dimensional coordinate system of the map, and for each of the position indices, the second position data represents a third coordinate in the three-dimensional coordinate system.

13. The server cluster system as claimed in claim 11, further comprising a network access point connected electrically between said first communication module of said positioning unit and said host device,
wherein said first communication module is configured to send the status information, the position indices and the first position data to said host device via said network access point.

14. The server cluster system as claimed in claim 11, wherein each of said second communication modules sends wirelessly the status information and the position index to said first communication module.

15. A server cluster system, comprising:
a server unit including a plurality of servers, each of said servers generating status information that is associated therewith;
a plurality of network communication modules connected electrically and respectively to said servers, each of said network communication modules storing a unique network address;
a host device in communication with said network communication modules and storing a plurality of reference addresses and a plurality of position indices, the position indices corresponding respectively to the reference addresses and being associated respectively with positions of said servers;
each of said network communication modules being configured to receive the status information from the respective one of said servers, and to send the status information received from the respective one of said servers and the network address stored therein to said host device.

16. The server cluster system as claimed in claim 15, further comprising a network access point connected electrically to said host device, each of said network communication modules being configured to send the status information and the network address to said host device via said network access point.

17. The server cluster system as claimed in claim 16, wherein said host device is configured to locate one of the position indices with reference to the reference address that conforms with the network address received from one of said network communication modules.

18. The server cluster system as claimed in claim 17, wherein each of said network communication modules is configured to output a wireless positioning signal;
wherein said server cluster system further comprises a portable electronic device that stores a map, and that is configured to
receive, from said host device, the position index located by said host device
receive the wireless positioning signals from said network communication modules and calculate a current position of said portable electronic device according to the wireless positioning signals, and
display the map, mark the position of one of said servers on the map according to the position index, and mark the current position of said portable electronic device on the map.

19. The server cluster system as claimed in claim 18, wherein each of the position indices includes a set of three coordinates that are in a three-dimensional coordinate system of the map and that are associated with the position of the respective one of said servers.

20. The server cluster system as claimed in claim 16, wherein each of said network communication modules is configured to communicate wirelessly with said network access point.
